(19) United States
(12) Patent Application Publication
(10) Pub. No.: US 2015/0049877 A1
(43) Pub. Date: Feb. 19, 2015

(54) ACOUSTIC DEVICE, OUTPUT SOUND MANAGEMENT DEVICE, TERMINAL DEVICE, AND OUTPUT SOUND CONTROL METHOD

(71) Applicant: PIONEER CORPORATION, Kawasaki-shi, Kanagawa (JP)

(72) Inventor: Toshiyuki Horie, Saitama (JP)

(21) Appl. No.: 14/386,037

(22) PCT Filed: Mar. 28, 2012
(86) PCT No.: PCT/JP2012/058243

§ 371 Date: Sep. 18, 2014

(51) Int. Cl. H04R 3/00

(52) U.S. Cl. CPC H04R 3/00
USPC 381/86

(57) ABSTRACT

During a sound pressure measurement operational mode, when a distance from a vehicle and a corresponding required sound pressure level are specified, a control part causes a test sound to be outputted externally from an external sound output part by making a sound signal generation part generate a test sound signal as an external output sound signal. By doing this, the control part controls the signal level of the test sound signal as a result of sound pickup by a sound pickup part of the test sound outputted outside the vehicle, and thereby determines an adjustment value for the signal level of the test sound signal that can minimize the output sound volume, while the externally outputted sound propagated through the space outside the vehicle still satisfies required sound pressure conditions. The control part registers the determined adjustment value in a sound pressure adjustment table within a storage part.

### TECHNICAL FIELD

The present invention relates to an acoustic device, an output sound management device, a terminal device, an output sound control method and an output sound control program, and a recording medium in which the output sound control program is recorded.

### BACKGROUND ART

In recent years, the popularity has increased rapidly of electric vehicles that employ batteries for supply of drive force, and of hybrid vehicles that employ batteries for partial supply of drive force. When a vehicle of this type is being propelled by drive force supplied by its battery, the level of drive noise is dramatically lowered as compared to the case of a conventional gasoline vehicle. As a result, it may happen that a pedestrian or the driver of a bicycle (hereinafter referred to as “a pedestrian or the like”) does not become aware of the existence of the vehicle if it is approaching from outside his field of view, i.e. from behind him or the like. The occurrence of this state of affairs is a serious problem from the point of view of traffic safety.

Due to this, a technique has been proposed of outputting an external sound corresponding to the traveling state of the vehicle to the exterior of the vehicle (see Patent Document #1: hereinafter referred to as “the prior art”). In this example of prior art technique, it is arranged to generate an external sound output signal, and to output external sound forward from the vehicle from a speaker or the like.

### PRIOR ART DOCUMENTS

### Patent Documents

Patent Document #1: Japanese Laid-Open Patent Publication 2005-253236.

### SUMMARY OF THE INVENTION

### Problems to be Solved by the Invention

The outputting of external sound to the exterior of the vehicle by employing the prior art technique example described above is performed in order to attract the attention of a pedestrian or the like by notifying him of the approach of the vehicle. In order to accomplish this, over the range in which a subject whose attention ought to be attracted may be anticipated to be present, it is necessary for the externally outputted sound arriving from the speaker to have a sound pressure level that is sufficient for attracting the attention of the subject.

If externally outputted sound is outputted from the speaker whose sound volume is high in order for its sound pressure level to be sufficient, this entails deterioration of the acoustic environment outside the range in which a subject whose attention should be attracted may be anticipated to be present. Due to this, it is desirable that, in the range in which a subject may anticipated to be present, externally outputted sound whose sound pressure level is both necessary and sufficient for attracting the attention of the subject should reach him.

In order to satisfy this condition of being both necessary and sufficient, it is required to measure in advance the relationship between the signal level of the external sound output signal and the sound pressure level of the abovementioned externally outputted sound, and to adjust the signal level of the external sound output signal on the basis of the result of this measurement. And it has been considered to perform this type of measurement by using a technique in which sounds of various types, which are generated when the vehicle is traveling, are measured manually in an anechoic chamber by operation of a measuring device.

However, such anechoic chambers are quite few in number. Moreover, since it is necessary to operate the measuring device by hand, accordingly the person doing the measurement is required to perform a great deal of work.

Due to this, a simple technique is desired that is capable of measuring the relationship between the signal level of the external sound output signal and the sound pressure level of the resulting externally outputted sound, and that is capable of reflecting the results of this measurement in adjustment of the signal level of the external sound output signal.

The present invention has been conceived in consideration of the circumstances described above, and its object is to provide an acoustic device, an output sound management device, a terminal device, and an output sound control method, all of novel types, that perform processing for outputting externally outputted sound having an appropriate sound pressure level.

### Means for Solving the Problems

According to a first standpoint, the present invention is an acoustic device that supplies an external sound output signal to an external sound output part that outputs sound to the exterior of a vehicle, comprising: a first acquisition part configured to acquire the sound pressure level of sound outputted by said external sound output part and picked up by a sound pickup part that is disposed at a predetermined position exterior to the vehicle; and a control part configured to control the signal level of said external sound output signal on the basis of the sound pressure level acquired by said first acquisition part and a target sound pressure level for said predetermined position.

According to a second standpoint, the present invention is an acoustic device that supplies an external sound output signal to an external sound output part that outputs sound to the exterior of a vehicle comprising: an acquisition part configured to acquire the sound pressure level of sound outputted by said external sound output part and picked up by a sound pickup part that is disposed at a predetermined position exterior to the vehicle; and a control part configured to control the signal level of said external sound output signal so that said sound pressure level approaches a sound pressure level that is set for said predetermined position.

According to a third standpoint, the present invention is an output sound management device, comprising: a reception part configured to receive the sound pressure level of sound outputted by an external sound output part that is installed to the vehicle and picked up by a sound pickup part that is disposed at a predetermined position exterior to the vehicle; a generation part configured to generate signal level control information for said external sound output signal on the basis of the result of reception by said reception part and a target sound pressure level at said predetermined position; and a transmission part configured to transmit the result of generation by said generation part.

According to a fourth standpoint, the present invention is a terminal device disposed within a vehicle comprising: a sound pressure level acquisition part configured to acquire the sound pressure level of sound outputted by an external sound output part and picked up by a sound pickup part, the external sound output part being installed to said vehicle, the sound pickup part being disposed at a predetermined position exterior to the vehicle; a transmission part configured to transmit the result of acquisition by said sound pressure level acquisition part; a reception part configured to receive control information for the signal level of an external sound output signal, the control information being generated on the basis of the result of acquisition by said sound pressure level acquisition part and a target sound pressure level for said predetermined position; and a control part configured to control the signal level of said external sound output signal on the basis of the result of reception by said reception part.

According to a fifth standpoint, the present invention is an output sound control method that controls an external sound output signal to an external sound output part that outputs sound to the exterior of a vehicle, comprising the steps of: an acquisition step of acquiring the sound pressure level of sound outputted by said external sound output part and picked up by a sound pickup part that is disposed at a predetermined position exterior to the vehicle; and a control step of controlling the signal level of said external sound output signal on the basis of the result of acquisition by said acquisition process and a target sound pressure level at said predetermined position.

According to a sixth standpoint, the present invention is an output sound control program causing a calculation part to execute an output sound control method according to the present invention.

According to a seventh standpoint, the present invention is a recording medium in that an output sound control program according to the present invention is recorded thereupon so as to be capable of being read by a calculation unit.

### BRIEF DESCRIPTION OF THE DRAWINGS

FIG. 1 is a figure showing the schematic configuration of an acoustic device according to a first embodiment of the present invention.

FIG. 2 is a figure showing the schematic configuration of a terminal device and an output sound management device according to a second embodiment of the present invention.

FIG. 3 is a figure showing the schematic configuration of a navigation device according to a first example of the present invention.

FIG. 4 is a figure for explanation of information data stored in a storage unit of FIG. 3.

FIG. 5 is a flow chart for explanation of processing by the device of FIG. 3 for determination of an adjustment value.

FIG. 6 is a flow chart for explanation of processing by the device of FIG. 4 for measurement of a sound pressure level.

FIG. 7 is a block diagram for explanation of the positional relationship of a terminal device and a server device according to a second example of the present invention.

FIG. 8 is a block diagram for explanation of the configuration of the terminal device of FIG. 7.

FIG. 9 is a block diagram for explanation of the configuration of the server device of FIG. 7.

### EMBODIMENTS FOR CARRYING OUT THE INVENTION

In the following, embodiments of the present invention will be explained with reference to the attached drawings. Note that, in the following explanation and drawings, the same reference symbols are attached to elements that are the same or equivalent, and duplicate explanation will be omitted.

### The First Embodiment

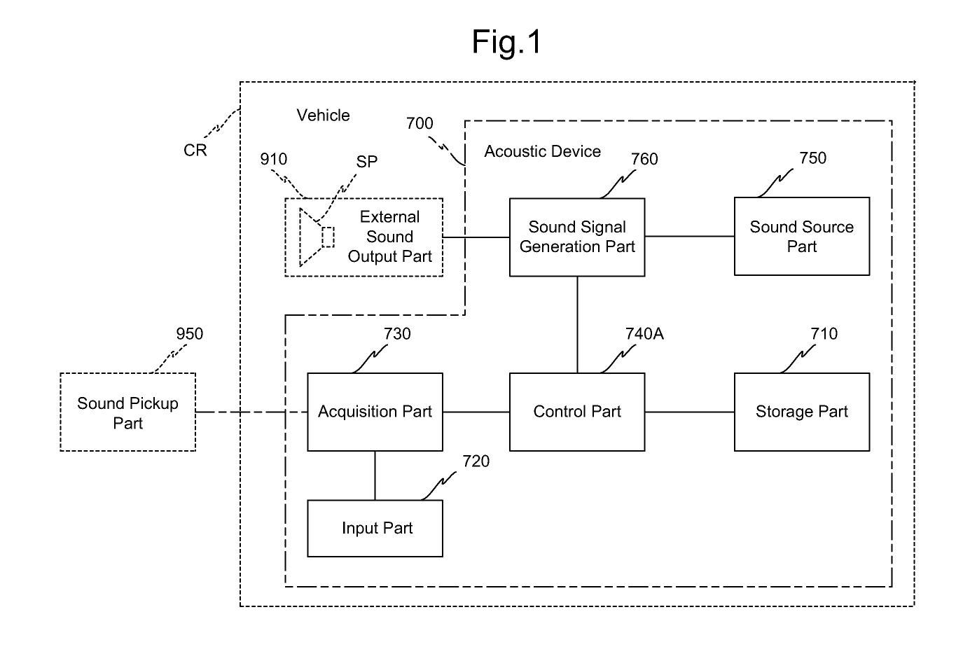

First, a first embodiment of the present invention will be explained with reference to FIG. 1.

### <Configuration>

In FIG. 1, the schematic configuration of an acoustic device 700 according to a first embodiment is shown. This acoustic device 700 is mounted to a vehicle CR that utilizes electrical energy as a part or as all of its drive energy.

An external sound output part 910 is installed within the vehicle CR. This external sound output part 910 includes a speaker SP that outputs external sound to the exterior of the vehicle on the basis of an external sound output signal that is sent from the acoustic device 700.

As shown in FIG. 1, the acoustic device 700 comprises a storage part 710, an input part 720, and an acquisition part 730 that serves as a first acquisition part and as a second acquisition part. Moreover, the acoustic device 700 comprises a control part 740A, a sound source part 750, and a sound signal generation part 760.

The storage part 710 stores information of various types for use by the acoustic device 700. Speaker characteristic information and a sound pressure adjustment table are included in this information. The control part 740A is capable of accessing the storage part 710.

The characteristics of sound pressure level attenuation along with increase of the propagation distance of externally outputted sound outputted from the speaker SP of the external sound output part 910 are included in the speaker characteristic information described above. For example, if the externally outputted sound outputted from the speaker SP is a wave upon the surface of a sphere, then its attenuation characteristic will be proportional to the inverse square of the distance.

At least one individual table is included in the sound pressure adjustment table described above. Note that one of the individual tables is a user table that a user can utilize individually. Moreover if there is a requirement for changing the method of sound pressure adjustment, due to differences in the country or the region or the like, then the appropriate number of individual tables are prepared.

Here, for each frequency that is to be a subject for adjustment (in the following, this will be termed an “adjustment subject frequency”), the correspondence between distance from the vehicle CR and the required sound pressure level is registered in each of the individual tables. Moreover, for each adjustment subject frequency, a sound pressure level adjustment value is registered in each of the individual table.

The input part 720 comprises a keyboard and so on. Setting of the details of operation by the acoustic device 700 and so on is performed by the user actuating this input part 720. The settings by the user include changing over between a normal operational mode and a sound pressure measurement operational mode, setting of measurement conditions during the sound pressure measurement operational mode, and setting of an individual table to be referred to during the normal operational mode. The results of input to the input part 720 are sent to an acquisition part 730.

Note that distance between a microphone included in a sound pickup part 950 and the vehicle CR, and settings for target sound pressure, are included in the measurement conditions. Moreover, note that specification of an individual table, or explicit specification of one or a plurality of groups of adjustment subject frequency, distance, and required sound pressure level, can be included in the specifications of target sound pressures.

The acquisition part 730 receives the sound pickup result sent from the sound pickup part 950, which is equipped with the microphone. And the acquisition part 730 sends this sound pickup result to the control part 740A.

Furthermore, the acquisition part 730 receives the results of input sent from the input part 720. And the acquisition part 730 sends these input results to the control part 740A.

In the sound pressure measurement operational mode, the control part 740A controls the sound pressure level of a test sound, which is an external sound that is outputted from the external sound output part 910, on the basis of the results of setting of measurement conditions sent from the acquisition part 730, and on the basis of the results of sound pickup sent from the sound pickup part 950. Moreover, in the normal operational mode, the control part 740A controls the sound pressure level of the external sound outputted from the external sound output part 910 on the basis of the setting results in the individual table sent from the acquisition part 730.

Note that the details of the processing executed by the control part 740A will be described hereinafter.

Sound data corresponding to externally outputted sound is stored in the sound source part 750. Sound data corresponding to sound outputted externally during the normal operational mode, and test sound data, which is sound data corresponding to subject frequency adjustment components for sound outputted externally during the abovementioned normal operational mode, are included in this sound data. The sound signal generation part 760 is capable of accessing the sound source part 750.

The sound signal generation part 760 has an equalizer function and generates an external sound output signal on the basis of control by the control part 740A. When generating this external sound output signal, firstly, the sound signal generation part 760 reads in sound data specified by the control part 740A from the sound source part 750. Then, on the basis of this sound data that has been read in, the sound signal generation part 760 performs adjustment of the signal level specified by the control part 740A, and generates an external sound output signal. The external sound output signal that has been generated in this manner is sent to the external sound output part 910.

### <Operation>

Next, the operation of the acoustic device 700 having the configuration described above will be explained.

### <<Operation During the Sound Pressure Measurement Operational Mode>>

Firstly, the operation will be explained when the sound pressure measurement operational mode has been specified by the user by actuation of the input part 720. Note that it will be supposed that, before setting of target sound pressures by actuation of the input part 720 by the user, along with the microphone included in the sound pickup part 750 having been disposed in a position that is exterior to the vehicle CR and corresponding to a target sound pressure, also the sound pickup part 950 has been connected to the acquisition part 730 of the acoustic device 700.

When the measurement conditions that have been set by input to the input part 720 are received via the acquisition part 730, the control part 740A starts the sound pressure measurement processing.

Upon receipt of these measurement conditions, firstly, for each of the adjustment subject frequencies that are included in these measurement conditions, the control part 740A determines target sound pressure levels at the positions of the microphones of the sound pickup part 950. During this determination of target sound pressure level, for an adjustment subject frequency for which only one pair of distance and required sound level is specified (for example, a frequency for which the designation of an individual table is made as the target sound pressure specification of the measurement conditions, and, in that individual table, only one pair of distance from the vehicle CR and required sound pressure level is specified), the control part 740A refers to the speaker characteristic information in the storage part 710, and determines the sound pressure level at the sound pickup position of the sound pickup part 950 that corresponds to that required sound pressure level as being the target sound pressure level.

Moreover, for an adjustment subject frequency for which a plurality of pairs of distance and required sound pressure level are specified (for example, a frequency for which the designation of an individual table is made as the target sound pressure specification of the measurement conditions, and, in that individual table, a plurality of pairs of distance from the vehicle CR and required sound pressure level are specified), the control part 740A refers to the speaker characteristic information in the storage part 710, and determines that pair for which it is necessary to make the test sound signal level be the highest. And the control part determines the sound pressure level at the pickup position of the sound pickup part 950 corresponding to the required sound pressure level of that specified pair as being the target sound pressure level corresponding to that adjustment subject frequency.

When the determination of target sound pressure level has been completed, then, for each adjustment subject frequency, the control part 740A executes a sound pressure measurement control procedure while taking that adjustment subject frequency as a subject frequency for measurement. During this sound pressure measurement control procedure, firstly, the control part 740A sends a command specifying the measurement subject frequency and a gain value, which is a prearranged value determined in advance, to the sound signal generation part 760 for generation of a test sound signal.

Upon receipt of this generation command for the test sound signal, the sound signal generation part 760 reads in from the sound source part 750 sound data corresponding to a test sound at the measurement subject frequency that has been designated. Subsequently, on the basis of the sound data that has been read in and the gain value that has been specified, the sound signal generation part 760 repeatedly generates this test sound signal as an external sound output signal. Then, the sound signal generation part 760 sends this external sound output signal that has thus been generated to the external sound output part 910. As a result, the test sound is outputted from the speaker SP of the external sound output part 910.

During this type of test sound output, the control part 740A receives the results of sound pickup by the sound pickup 950 via the acquisition part 730. And, on the basis of these sound pickup results sent from the sound pickup part 950, the control part 740A calculates the difference between the sound pressure level of the test sound at the sound pickup position, and the target sound pressure level.

Subsequently, on the basis of the calculated difference and the gain value at the present time point, the control part 740A derives a gain value for which it is anticipated the difference will become smaller. And the control part 740A sends to the sound signal generation part 760 a gain correction specification in which this gain value that has been derived is specified.

As a result, a test sound signal upon which gain correction has been performed is sent from the sound signal generation part 760 to the external sound output part 910. And the sound pressure level at the position of sound pickup by the sound pickup part 950 changes.

After that, on the basis of the result of sound pickup, the control part 740A repeats calculation of the difference between the sound pressure level and the target sound pressure level at the sound pickup position for the test sound, and repeats gain correction specification, until the most recently calculated difference becomes greater than or equal to the difference calculated the previous time. And, when the most recently calculated difference becomes greater than or equal to the difference calculated the previous time, then the control part 740A registers the gain value for which the difference was obtained that previous time into the sound pressure adjustment table in the storage part 710, as being the adjustment value corresponding to the measurement subject frequency at the present time point.

Note that, if an individual table was specified as the target sound pressure specification in the measurement conditions that were set, then the control part 740A registers the gain value for which the difference was calculated the abovementioned time before into the individual table that was specified, as being the adjustment value corresponding to the measurement subject frequency at the present time point. On the other hand, if a frequency, a distance, and a required sound pressure level were specified as the target sound pressure specification in the measurement conditions that were set, then the control part 740A registers the gain value for which the difference was calculated the abovementioned time before into the user table, as being the adjustment value corresponding to the measurement subject frequency at the present time point.

As described above, for all of the frequencies that are subjects of adjustment, adjustment values that satisfy the target sound pressure specifications in the measurement conditions are registered in the sound pressure adjustment table in the storage part 710.

### <<Operation During the Normal Operational Mode>>

Next, the operation will be explained when the normal operational mode has been specified by the user by actuation of the input part 720. Note that, during this normal operational mode, the sound pickup part 950 is not connected to the acquisition part 730 of the acoustic device 700. Moreover, during the normal operational mode, when the vehicle CR is traveling, it will be supposed that external sound is being outputted from the external sound output part 910 in order to attract attention to the fact that the vehicle CR is approaching.

If the vehicle CR is traveling during this normal operational mode, then the control part 740A refers to the individual table that has been set according to the most recently specified setting for the individual table to be referred to, as designated by input actuation by the user on the input part 720. And the control part 740A performs control of the sound signal generation part 760 by taking the adjustment value corresponding to an adjustment subject frequency that is registered in the individual table referred to as being the gain value for the component of that adjustment subject frequency. As a result, externally outputted sound is outputted from the external sound output part 910 whose output sound volume has been minimized while still satisfying the conditions for required sound pressure level that have been specified by the user.

As has been explained above, according to this first embodiment, during the sound pressure measurement operational mode, when specifying measurement conditions including pairs of distance from the vehicle CR and required sound pressure level, the control part 740A generates a test sound signal as an external sound output signal and causes the test sound to be outputted from the external sound output part 910 as an externally outputted sound. The test sound that has been outputted to the exterior of the vehicle in this manner is picked up by the sound pickup part 950. And, by the control part 740A controlling the signal level of the test sound signal on the basis of the sound pickup result, an adjustment value for the signal level of the test sound signal is obtained that can minimize the output sound volume of the externally outputted sound that is propagated through the space exterior to the vehicle while still satisfying the condition for the required sound pressure level. And the control part 740A registers this adjustment value that has been obtained in the sound pressure adjustment table in the storage part 710.

Thus, according to this first embodiment, it is possible to output external sound whose sound volume has been minimized while still satisfying the desired condition for the required sound pressure level.

Moreover, in this first embodiment, if there is a plurality of adjustment subject frequencies, an adjustment value for the signal level of the test sound signal is obtained for each of the plurality of adjustment subject frequencies. Due to this, it is possible to perform very fine optimization of the sound pressure level of the externally outputted sound.

### The Second Embodiment

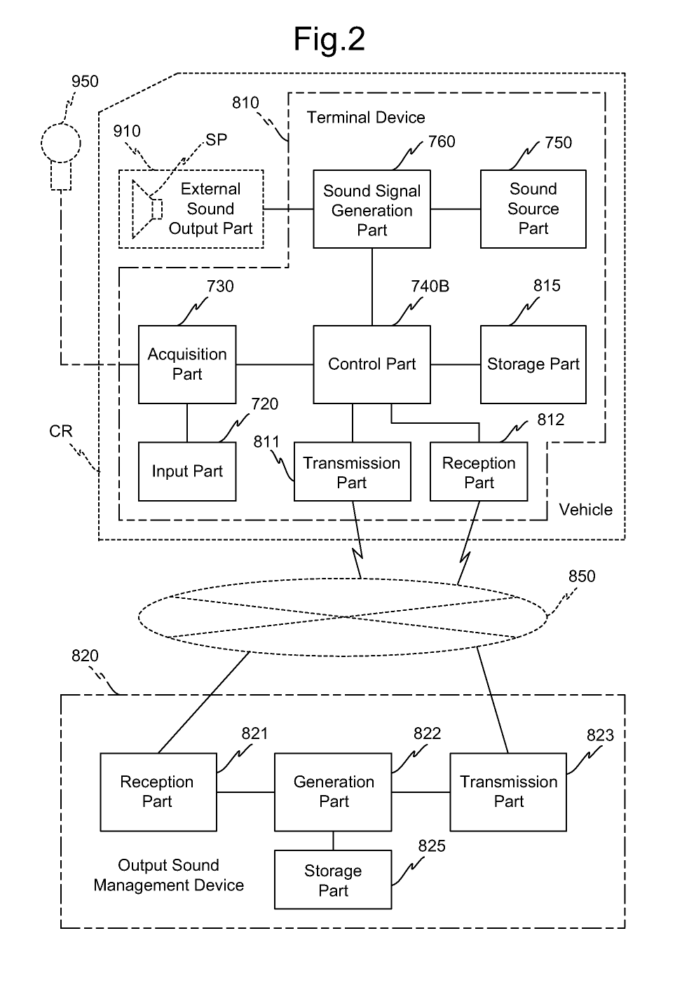

Next, a second embodiment of the present invention will be explained with reference to FIG. 2.

### <Configuration>

The schematic configuration of a terminal device 810 and an output sound management device 820 according to a second embodiment of the present invention are shown in FIG. 2. As shown in this FIG. 2, the terminal device 810 is adapted to be operated when installed within a vehicle CR. Moreover, the output sound management device 820 is disposed outside the vehicle CR. And the terminal device 810 and the output sound management device 820 are capable of mutual communication via a network 850.

Note that the output sound management device 820 is capable of also communicating with other terminal devices which have configurations similar to that of the terminal device 810, but only the terminal device 810 is shown in FIG. 2, as a representative.

### <<Configuration of the Terminal Device 810>>

As compared with the acoustic device 700 of the first embodiment described above, the terminal device 810 differs by the feature that it is provided with a control part 740B instead of the control part 740A, by the feature that it is provided with a transmission part 811 and a reception part 812, and by the feature that it is provided with a storage part 815 instead of the storage part 710. In the following, the explanation will principally focus upon these points of difference.

During the sound pressure measurement operational mode, the control part 740B receives the result of sound pickup sent from the sound pickup part 950 via the acquisition part 730. And the control part 740B sends this sound pickup result to the transmission part 811 as terminal transmission data. Moreover, during the sound pressure measurement operational mode, when input for setting measurement conditions is performed on the input part 720, the control part 740B receives these measurement conditions via the acquisition part 730. And the control part 740B sends these measurement conditions to the transmission part 811 as terminal transmission data.

Moreover, during the sound pressure measurement operational mode, the control part 740B receives, via the network 850 and the reception part 812, control information for the sound pressure of the external sound outputted by the external sound output part 910, wherein the control information is transmitted from the output sound management device 820. And the control part 740B controls the signal level of the test sound signal according to this control information. Moreover, in a similar manner to the case with the control part 740A described above, the control part 740B issues commands to the sound signal generation part 760 for generation of an external sound output signal both during the sound pressure measurement operational mode and during the normal operational mode, and also performs control of the signal level of the external output signal during the normal operational mode.

Note that the details of the processing executed by the control part 740B will be described hereinafter.

The transmission part 811 receives the terminal transmission data sent from the control part 740B. And the transmission part 811 transmits this terminal transmission data to the output sound management device 820 via the network 850.

The reception part 812 receives the control information for the sound pressure of the externally outputted sound sent from the output sound management device 820 via the network 850. And the reception part 812 sends this control information to the control part 740B.

In a similar manner to the case with the storage part 710 described above, sound pressure adjustment table is stored in the storage part 815 mentioned above. On the other hand, the feature that no speaker characteristic information is stored in the storage part 815 is different from the case with the storage part 710.

### <<Configuration of the Output Sound Management Device 820>>

As shown in FIG. 2, the output sound management device 820 comprises a reception part 821, a generation part 822, a transmission part 823, and a storage part 825.

The reception part 821 mentioned above receives the terminal transmission data sent from the terminal device 810 via the network 850. And the reception part 821 sends this terminal transmission data that it has received to the generation part 822.

The generation part 822 receives the measurement conditions and the sound pickup result sent from the reception part 821 as terminal transmission data. And, on the basis of this sound pickup result, the generation part 822 generates control information for controlling the sound pressure level of the externally outputted sound that is propagated through the space exterior to the vehicle. The control information that has been generated in this manner is sent to the transmission part 823.

The transmission part 823 receives the control information sent from the generation part 822. And the transmission part 823 transmits this control information to the terminal device 810 via the network 850.

Speaker characteristic information is stored in the storage part 825 mentioned above, in a similar manner to the case with the storage part 710 described above. On the other hand, the feature that no sound pressure adjustment tables are stored in the storage part 825 is different from the case with the storage part 710.

With the configuration of the terminal device 810 and the configuration of the output sound management device 820 as described above, the target sound pressure level and the result of sound pickup by the sound pickup part 950 gathered by the control part 740 are sent to the generation part 822 via the transmission part 811, the network 850, and the reception part 821. Moreover, the control information generated by the generation part 822 is sent to the control part 740B via the transmission part 823, the network 850, and the reception part 812.

### <Operation>

Next, the control procedure for the sound pressure of the externally outputted sound executed by cooperation between the terminal device 810 and the output sound management device 820 having the configuration described above will be explained.

### <<Operation During the Sound Pressure Measurement Operational Mode>>

Firstly, the operation will be explained when the sound pressure measurement operational mode has been specified by the user by actuation of the input part 720 of the terminal device 810. Note that it will be supposed that, before setting of measurement conditions by actuation of the input part 720 by the user, along with the microphone of the sound pickup part 750 having been disposed in a position that is exterior to the vehicle CR and that corresponds to a target sound pressure, also the sound pickup part 950 has been connected to the acquisition part 730 of the terminal device 810.

When setting of the measurement conditions has been performed, the control part 740B of the terminal device 810 sends the measurement conditions that have been set to the generation part 822 of the sound output management device 820. Upon receipt of these measurement conditions, the generation part 822 refers to the speaker characteristic information in the storage part 825, and determines a target sound pressure level at the sound pickup part 950 with respect to each of the adjustment subject frequencies included in the measurement conditions, in a similar manner to the case with the control part 740A of the first embodiment described above. And the generation part 822 sends control information to the control part 740B, specifying the first measurement subject frequency and a prearranged gain value.

Upon receipt of this control information, the control part 740B sends to the sound signal generation part 760 a test sound signal generation command specifying the measurement subject frequency and the gain value that are specified by the control information. And upon receipt of this test sound signal generation command, in a similar manner to the case with the first embodiment described above, the sound signal generation part 760 generates a test sound signal as an external sound output signal, and sends the generated test sound signal to the external sound output part 910 as an external sound output signal. As a result, the test sound is outputted from the speaker SP of the external sound output part 910.

During this output of the test sound, the control part 740B receives the result of sound pickup by the sound pickup part 950 via the acquisition part 730. And the control part 740B sends this sound pickup result to the generation part 822.

Upon receipt of the sound pickup result, the generation part 822 calculates, on the basis of this sound pickup result, the sound pressure level at the pickup position for the test sound, and the difference between the test sound pressure level and the target sound pressure level, in a similar manner to the case with the control part 740A described above. And repeatedly, on the basis of the calculated difference and the gain value at the present time point, the generation part 822 derives a gain value which it is considered will make the difference smaller. And the generation part 822 sends the gain value correction specification that has thus been derived to the control part 740B as control information.

Upon receipt of this control information whose content is the specification of gain correction, the control part 740B sends the gain correction specification to the sound signal generation part 760, then sends a report, which means that the specification of gain correction has been completed, to the gain correction part 822.

Subsequently, the control part 740B repeats transmission of the result of sound pickup by the sound pickup part 950 to the generation part 822, gain correction specification according to the control information sent from the generation part 822, and reporting to the generation part 822 that the gain correction specification has been completed. Moreover, the generation part 822 repeats the difference calculation, until the difference that is newly calculated after receipt of the completion of gain correction specification sent from the control part 740B becomes greater than or equal to the difference that was calculated the time before.

And when the newly calculated difference becomes greater than or equal to the difference that was calculated the time before, the generation part 822 determines the gain value for which this difference that was calculated the time before was obtained as being the adjustment value that corresponds to the measurement subject frequency at the present time point. And the generation part 822 sends a notification of individual measurement ending to the control part 740B, including a pair consisting of the measurement subject frequency at the present time point and the adjustment value that has been determined. Upon receipt of this individual measurement end notification, the control part 740B registers this gain value that has been determined in the sound pressure adjustment table in the storage part 815, as the adjustment value corresponding to the measurement subject frequency at this present time point.

After that, the control part 740B and the generation part 822 repeat processing similar to that described above, until an adjustment value has been determined corresponding to each of the adjustment subject frequencies that were set in the measurement conditions. Then, after individual measurement end notifications have been sent for all of the adjustment subject frequencies set in the measurement conditions, then the generation part 822 sends a measurement end notification to the control part 740B.

As described above, in correspondence to the measurement conditions set by the user, adjustment values for the signal level of the external sound output signal are determined, and are registered in the sound pressure adjustment table in the storage part 815.

### <<Operation During the Normal Operational Mode>>

Next, the operation when the normal operational mode has been designated by actuation of the input part 720 by the user will be explained. Note that, during this normal operational mode, the acquisition part 730 of the terminal device 810 is not connected. Moreover it will be supposed that, during the normal operational mode, and when also the vehicle CR is traveling, external sound is being outputted from the external sound output part 910 in order to attract attention to the fact that the vehicle CR is approaching.

During the normal operational mode, and moreover when the vehicle CR is not traveling, in a similar manner to the case for the control part 740A described above, the control part 740B refers to the individual table that has been set, according to the setting for the individual table that is to be referred to that has been most recently designated by input actuation by the user to the input part 720. And the control part 740B performs control of the sound signal generation part 760 so as to make the gain value for this adjustment subject frequency component be equal to the adjustment value registered in the individual table referred to that corresponds to that adjustment subject frequency. As a result, external sound is outputted from the external sound output part 910, whose output sound volume is minimized while still satisfying the condition specified by the user for the required sound pressure level.

As explained above, according to this second embodiment, during the sound pressure measurement operational mode, the test sound that is outputted to the exterior of the vehicle is picked up by the sound pickup part 950. The control part 740B of the terminal device 810 and the generation part 822 of the output sound management device 820 cooperate together, and, by controlling the signal level of the test sound signal on the basis of the result of sound pickup by the sound pickup part 950, obtain an adjustment value for the signal level of the test sound signal that can minimize the output sound volume while the externally outputted sound that is propagated through the space exterior to the vehicle still satisfies the condition on the required sound pressure level. And the adjustment value that has thus been obtained is registered in the sound pressure adjustment table in the storage part 815.

Thus, according to this second embodiment, in a similar manner to the case with the first embodiment described above, it is possible to output an external sound whose sound volume has been minimized while still satisfying the condition on the desired required sound pressure level.

Moreover, according to this second embodiment, in a similar manner to the case with the first embodiment described above, if there is a plurality of adjustment subject frequencies, then an adjustment value for the signal level of the test sound signal is obtained for each of that plurality of adjustment subject frequencies. By doing this, it is possible to perform very fine optimization of the sound pressure level of the externally outputted sound.

### Modification of the Embodiments

Changes of various types can be implemented to the first and second embodiments described above.

For example, in the first and second embodiments, if the difference that is newly calculated is greater than or equal to the difference that was calculated the time before, then it was arranged to register the gain value for which this difference that was calculated the time before was obtained as the adjustment value in the sound pressure adjustment table. By contrast to this, it would also be acceptable to arrange, if the difference that is calculated is less than or equal to some permitted value that is determined in advance, to register the gain value at this time point as the adjustment value in the sound pressure adjustment table.

Moreover, in the first and second embodiments, when determining the adjustment values, it was arranged to output a test sound for each of the adjustment subject frequencies, and to determine an adjustment value corresponding to each of the adjustment subject frequencies. By contrast to this, when determining the adjustment values, it would also be acceptable, during the normal operational mode, to arrange to output a sound based upon sound data corresponding to externally outputted sound as a test sound, and to determine an adjustment value corresponding to each of the adjustment subject frequencies while performing frequency analysis of the result of sound pickup.

Moreover, in the first and second embodiments, it was arranged to perform measurement of the sound pressure level without changing the position of the sound pickup part 950. By contrast to this, if, as specified in the measurement conditions, there are a plurality of distances from the vehicle CR at which it is necessary to perform measurement of the sound pressure levels, then it would also be possible to arrange, each time the sound pressure level is to be measured for one of these distances, to change the position of the microphone of the sound pickup part 950 to one of the positions specified by the measurement conditions.

Moreover, in the first and second embodiments, it was supposed that a single sound pickup part 950 was used. By contrast to this, it would also be acceptable to arrange to use several sound pickup parts at distances from the vehicle CR for which it is specified by the measurement conditions that it is necessary to perform measurement of sound pressure levels, to arrange the microphones of the sound pickup parts in positions at those distances, and to perform measurement of the sound pressure levels there. In this case, it is possible to omit the processing for determination of the target sound pressure levels.

Moreover, in the first embodiment, it was arranged for the acoustic device to include the storage part, the input part, the sound source part, and the sound signal generation part. By contrast to this, if parts that can serve as these parts and that can be shared are provided to some other device, then it would be acceptable to arrange to share these parts which are sharable. In this case, it would be possible to omit these sharable parts as elements of the acoustic device.

Moreover, in the second embodiment, it was arranged for the terminal device to include the storage part, the input part, the sound source part, and the sound signal generation part. By contrast to this, if some other device is included that is provided with parts that can be shared in order to provide the functions of the above parts, then it would also be acceptable to arrange to employ those parts which are sharable. In this case, it would be possible not to include those sharable parts as configuration elements of the terminal device.

Moreover, in the second embodiment, it was arranged for the output sound management device to keep the speaker characteristic information. By contrast to this, it would also be acceptable to arrange for the speaker characteristic information to be transmitted from the terminal device to the output sound management device, each time that measurement conditions are generated.

Note that it would also be acceptable to arrange to execute a portion, or all, of the processing by the acquisition part, the control part, and the sound signal generation part of the acoustic device of the first embodiment described above by implementing those parts with a computer that serves as a calculating part comprising a central processing device (CPU: Central Processing Unit) and a DSP (Digital Signal Processor) and so on, and by executing a program that is prepared in advance upon that computer. This program may be recorded upon a computer-readable recording medium such as a hard disk, a CD-ROM, a DVD or the like, and may be loaded into the computer from the recording medium and then executed. Moreover, it would be possible to arrange for this program to be acquired in the format of being recorded upon a transportable recording medium such as a CD-ROM, a DVD or the like; or, alternatively, it would also be possible to arrange for it to be acquired in the format of being distributed via a network such as the internet or the like.

Yet further, it would also be acceptable to arrange to execute a portion, or all, of the processing by the acquisition part, the control part, the sound signal generation part, and the generation part of the output sound management device of the terminal device of the second embodiment described above by implementing those parts with a computer that serves as a calculating part comprising a central processing device (CPU: Central Processing Unit) and a DSP (Digital Signal Processor) and so on, and by executing a program that is prepared in advance upon that computer. This program may be recorded upon a computer-readable recording medium such as a hard disk, a CD-ROM, a DVD or the like, and may be loaded into the computer from the recording medium and then executed. Moreover, it would be possible to arrange for this program to be acquired in the format of being recorded upon a transportable recording medium such as a CD-ROM, a DVD or the like; or, alternatively, it would also be possible to arrange for it to be acquired in the format of being distributed via a network such as the internet or the like.

### EXAMPLES

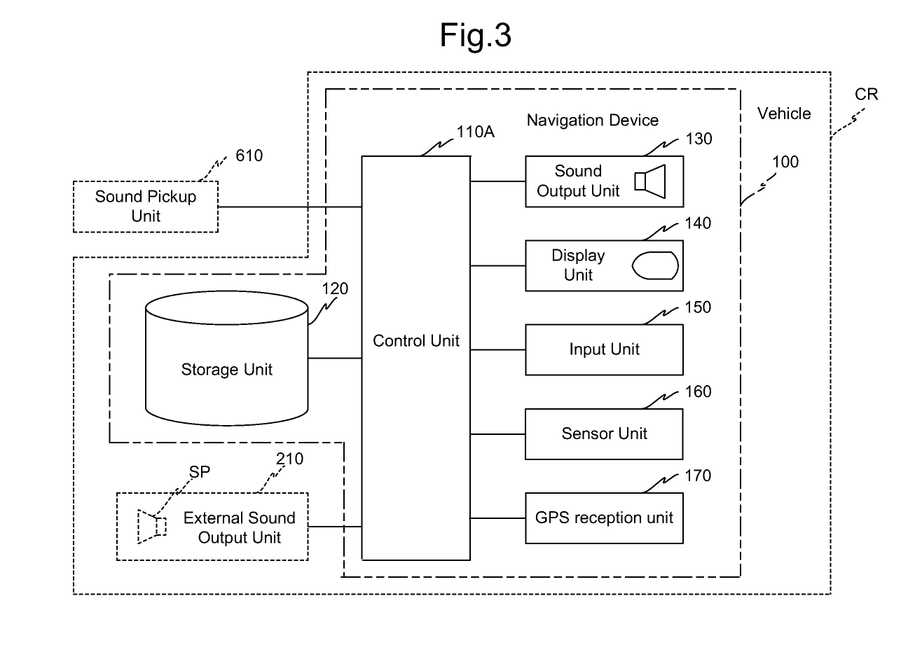

In the following, examples of the present invention will be explained with reference to FIGS. 3 through 9. Note that, in the following explanation and drawings, the same reference symbols will be appended to elements that are the same or equivalent, and duplicated explanation will be omitted.

### The First Example

Firstly, a first example of the present invention will be explained with reference to FIGS. 3 through 6.

The schematic configuration of a navigation device 100, which is an acoustic device according to the first example, is shown in FIG. 3. This is a concrete example of the acoustic device 700 of the first embodiment described above (refer to FIG. 1).

This navigation device 100 is mounted to a vehicle CR which uses electrical energy as a part or as all of its propulsive energy. An external sound output unit 210 is installed within this vehicle CR, and fulfills the function of the external sound output part 910. This external sound output unit 210 comprises a speaker SP which outputs external sound to the exterior of the vehicle according to an external sound output signal sent from the navigation device 100.

As shown in FIG. 3, the navigation device 100 comprises a control unit 110A and a storage unit 120 that fulfills the function of the storage part 710. Moreover, the navigation device 100 comprises a sound output unit 130, a display unit 140, and an input unit 150 that fulfills the function of the input part 720. Yet further, the navigation device 100 comprises a sensor unit 160 and a GPS (Global Positioning System) reception unit 170.

The control unit 110A controls the entire navigation device 100 as a whole. This control unit 110A will be described hereinafter.

The storage unit 120 includes a non-volatile storage device such as a hard disk device or the like. The control unit 110A is adapted to be capable of accessing this storage unit 120. Note that the information and data stored in the storage unit 120 will be described hereinafter.

The sound output unit 130 includes a speaker, and outputs sound corresponding to sound data sent from the control unit 110A. And, on the basis of control by the control unit 110A, this sound output unit 130 outputs guidance sounds related to navigation processing, such as the direction of progression of the vehicle CR, traveling conditions, traffic conditions, and so on.

The display unit 140 comprises a display device such as a liquid crystal panel or the like, and displays images corresponding to display data sent from the control unit 110A. During navigation processing, on the basis of control by the control unit 110A, this display unit 140 displays images and guidance information and so on such as map information, path information, and the like.

The input unit 150 comprises a key unit provided in the main body portion of the navigation device 100, and/or a remote input device that includes a key unit. Here, a touch panel that is provided on the display device of the display unit 140 may be used as the key unit that is provided to the main body portion. Note that, instead of this configuration that includes a key unit, or in parallel therewith, it would also be possible to employ a configuration in which input is provided by voice using a voice recognition technique.

Settings for the details of the operation of the navigation device 100 are made by the user actuating this input unit 150, and operating commands are issued. For example, the user makes settings such as a destination related to route searching by navigation processing and so on by using the input unit 150. Moreover, a changeover setting between the normal operational mode and the sound pressure measurement operational mode, and settings for measurement conditions during the sound pressure measurement operational mode, are performed by the user employing the input unit 150. Input details of this type are sent from the input unit 150 to the control unit 110A as input data.

The sensor unit 160 includes a vehicle speed sensor, an acceleration sensor, an angular velocity sensor, a tilt sensor, and so on. The results of detection by these sensors included in the sensor unit 160 are sent to the control unit 110A as sensor data.

The GPS reception unit 170 calculates the current position of the vehicle CR on the basis of the results of reception of radio waves that are sent from a plurality of the GPS satellites. Moreover, this GPS reception unit 170 specifies the current time on the basis of date and time information sent from the GPS satellites. This information specifying the current position and the present time instant is sent to the control unit 110A as GPS data.

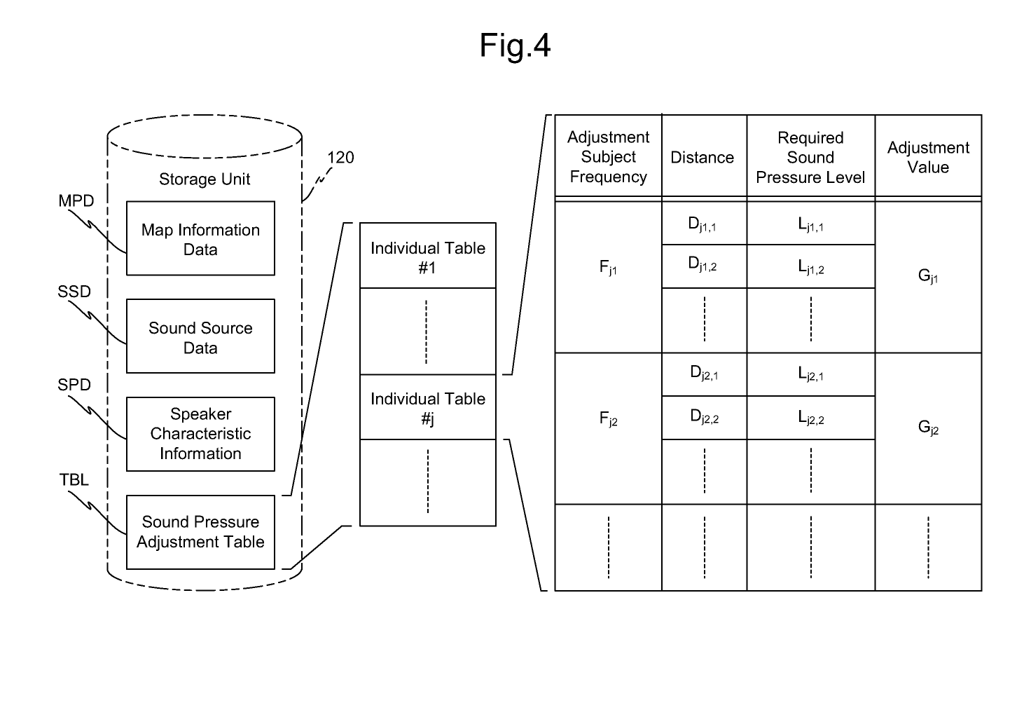

Next, the information and data stored in the storage unit 120 described above will be explained. Various kinds of information and data used by the navigation device 100 are stored in the storage unit 120. This information and data include map information data MPD, sound source data SSD, speaker characteristic information SPD, and a sound pressure adjustment table TBL, as shown in FIG. 4.

Road information such as road network information and so on is included in the map information data MPD. Moreover, sound data corresponding to sound outputted externally during the normal operational mode, and sound data corresponding to a test sound, which is the sound outputted externally during the sound pressure measurement operational mode, is included in the sound source data SSD. Here, this test sound is a sound having a frequency component of the adjustment subject frequency in the externally outputted sound during the normal operational mode.

Information is included in the speaker characteristic information SPD, specifying the attenuation characteristic of the sound pressure level, which increases along with the propagation distance of the externally outputted sound outputted from the speaker SP of the external sound output unit 210. For example, if the sound outputted externally from the speaker SP is a spherical surface wave, then this attenuation characteristic will be expressed as being proportional to the inverse square of the distance.

Individual tables #1, . . . are included in the sound pressure adjustment table TBL. Note that the individual table #1 is a user table that is used personally by a user. Moreover, if it is necessary to change the method for sound pressure adjustment due to differences between countries and/or between regions, then the necessary number of individual tables #2, . . . for changing the method of sound pressure adjustment are included in this sound pressure adjustment table TBL.

Here, for each adjustment subject frequency Fⱼₖ (where j=k, . . . ), at least one pair of distance D_{jk,s} (where s=1, . . . ) from the vehicle CR and required sound pressure level L_{jk,s} is registered in each individual table #j (where j=1, . . . ). Moreover, an adjustment value Gⱼₖ is registered in the individual table #j for each adjustment subject frequency Fⱼₖ. Note that the adjustment value Gⱼₖ is a parameter value for controlling the sound pressure of the component of the adjustment subject frequency Fⱼₖ in the externally outputted sound during the normal operational mode.

Next, the control unit 110A mentioned above will be explained. This control unit 110A includes a central processing device (CPU) and its peripheral circuitry. Various functions of the navigation device 100 are implemented by the control unit 110A executing programs of various types. The functions of the acquisition part 730, the control part 740A, and the sound signal generation part 760 in the first embodiment described above are included among these functions.

Note that the program that is executed by the control unit 110A is recorded upon a computer-readable recording medium such as a hard disk, a CD-ROM, a DVD or the like, and is loaded from that recording medium and then executed. Moreover, it would be possible to arrange for this program to be acquired in the format of being recorded upon a transportable recording medium such as a CD-ROM, a DVD or the like; or, alternatively, it would also be possible to arrange for it to be acquired in the format of being distributed via a network such as the internet or the like.

On the basis of the sensor data received from the sensor unit 160 and the GPS data received from the GPS reception unit 170, this control unit 110A refers as appropriate to the map information data MPD in the storage unit 120, and performs processing for supplying navigation information to the user. In this processing for supply of navigation information, processing is performed for: (a) map display for displaying a map of a region designated by the user upon the display device of the display unit 140; (b) map matching for calculating at what position the vehicle CR is upon the map, and for calculating in what azimuth it is facing; (c) searching for a path from the position where the vehicle currently is located to a destination, which is a desired position specified by the user; (d) when driving to a destination along a path that has been set, calculating a forecast time instant for arrival at the destination; and (e) performing control processing for providing a guidance display upon the display device of the display unit 140 and for outputting voice guidance from the speaker of the sound output unit 130, wherein information the guidance includes the map matching result, the forecast arrival time that has been calculated, the direction in which the vehicle should proceed and so on.

Furthermore, during the sound pressure measurement operational mode, the control unit 110A controls the sound pressure level of a test sound, which is an externally outputted sound outputted from the external sound output unit 210, on the basis of the result of sound pickup sent from a sound pickup unit 610 which includes a microphone. Moreover, during the normal operational mode, the control unit 110A controls the pressure level of the externally outputted sound according to the contents of the individual table which has been designated as being the one to be referred to.

Note that the control procedure for the sound pressure level of the externally outputted sound executed by the control unit 110A will be described hereinafter.

### <Operation>

Next, the operation of the navigation device 100 having the configuration as described above will be explained, with attention being principally focused upon the control procedure for the sound pressure level of the externally outputted sound executed by the control unit 110A.

### <<Operation During the Sound Pressure Measurement Operational Mode>>

Firstly, the operation when the sound pressure measurement operational mode has been specified by actuation by the user upon the input unit 150 will be explained. Note that it will be supposed that, before setting of the measurement conditions by actuation upon the input unit 150 by the user, along with the microphone included in the sound pickup unit 610 being disposed in a position exterior to the vehicle CR, also the sound pickup unit 610 is connected to the control unit 110A of the navigation device 100.

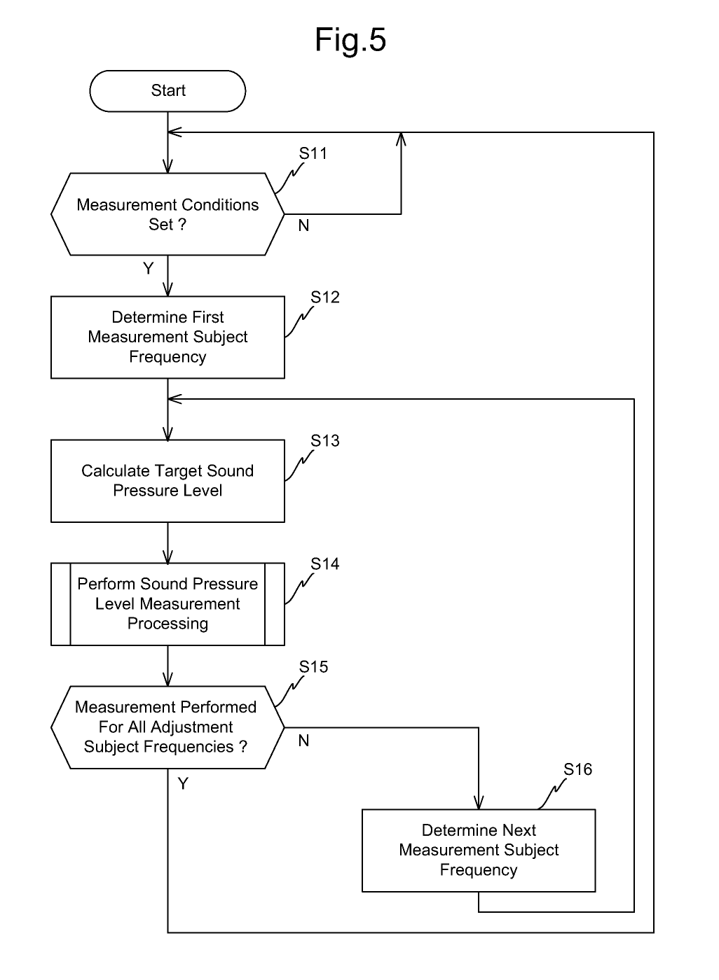

When the sound pressure measurement operational mode is designated, firstly, as shown in FIG. 5, in a step S11 the control unit 110A makes a decision as to whether or not measurement conditions have been newly set. Here, the distance between the microphone included in the sound pickup unit 610 and the vehicle CR, and a specification for target sound pressure, are included in the measurement conditions.

Note that, as the target sound pressure specifications, one of the individual tables #1, . . . may be designated, or one or a plurality of explicit specifications each of which consists of a group of adjustment subject frequency, distance, and required sound pressure level can be specified.

If the result of the decision in the step S11 is negative (N in the step S11), then the processing of the step S11 is repeated. But if measurement conditions have been newly set so that the result of the decision in the step S11 is affirmative (Y in the step S11), then the flow of control proceeds to a step S12. Note that, if an explicit specification of the type described above has been specified, then the control unit 110A registers the details of that explicit specification in a user table (the individual table #1) in the storage unit 120.

In the step S12, the control unit 110A determines the first measurement subject frequency among the adjustment subject frequencies included in the measurement conditions that have been set. Then in a step S13, the control unit 110A determines the target sound pressure level by referring to the individual table in the storage unit 120 corresponding to the speaker characteristic information SPD and the measurement conditions.

During this determination of the target sound pressure level, if a plurality of pairs of distance and required sound pressure level have been specified for this measurement subject frequency (for example, if specification of an individual table has been made as the target sound pressure specification in the measurement conditions, and a plurality of pairs of distance from the vehicle CR and required sound pressure level are registered in that individual table), then the control unit 110A specifies, on the basis of the speaker characteristic information SPD in the storage unit 120, that pair for which it is necessary for the signal level of the test sound signal to be made the highest. Then, on the basis of the speaker characteristic information SPD, the control unit 110A determines the sound pressure level at the sound pickup position of the sound pickup unit 610 corresponding to the required sound pressure level in the specified pair as being the target sound pressure level corresponding to the measurement subject frequency.

Next, in a step S14, measurement processing is performed for the sound pressure level at this measurement subject frequency. Note that the details of this sound pressure level measurement processing will be described hereinafter.

When the processing of the step S14 has been completed, the flow of control proceeds to a step S15. In this step S15, the control unit 110A makes a decision as to whether or not sound pressure level measurement processing has been completed for all of the adjustment subject frequencies that were set in the measurement conditions.

If the result of the decision in the step S15 is negative (N in the step S15), then the flow of control proceeds to a step S16. In this step S16, after having determined the next measurement subject frequency, the control unit 110A determines the target sound pressure level in a similar manner to the case in the step S12 described above. Then the flow of control returns to the step S13.

Subsequently the processing of the steps S13 through S16 is repeated until the result of the decision in the step S15 becomes affirmative. And when the result of the decision in the step S15 becomes affirmative (Y in the step S15), then the flow of control returns to the step S11. After that, the processing of the steps S11 through S16 is repeated.

### <<The Sound Level Measurement Processing>>

Next, the measurement processing for sound pressure level in the step S14 will be explained.

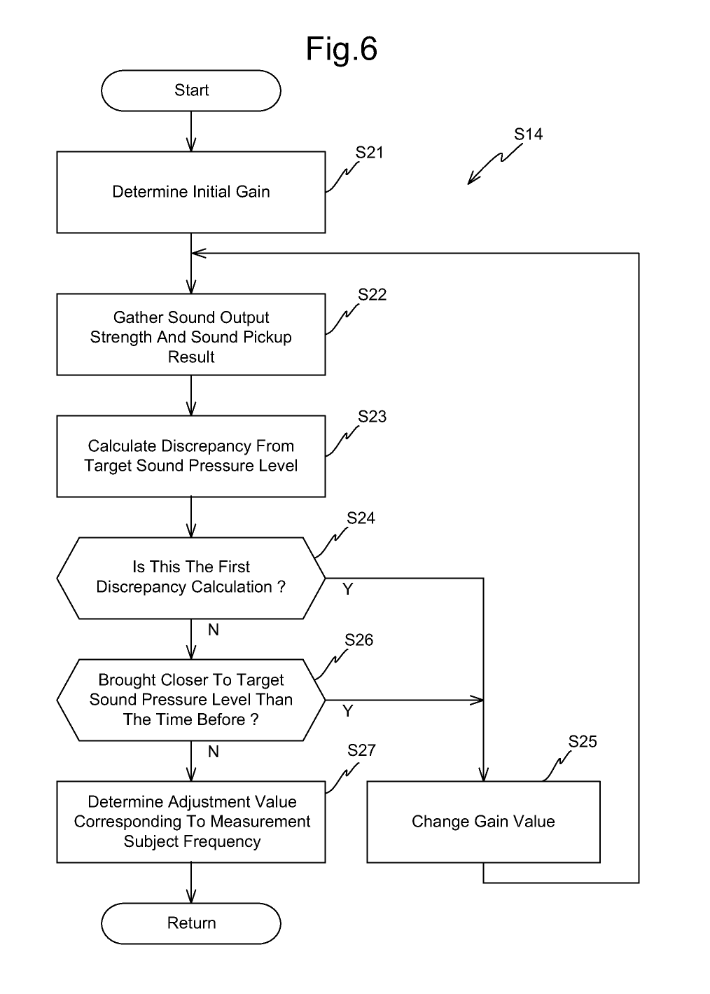

During the sound pressure level measurement processing, firstly, as shown in FIG. 6, in a step S21 the control unit 110A determines a prearranged gain value as being the initial gain value. And then, in a step S22, the control unit 110A reads in sound data from the storage unit 120 corresponding to test sound of the measurement frequency. Subsequently, on the basis of the sound data that has thus been read in and the determined gain value, the control unit 110A repeatedly generates a test sound signal as an external sound output signal. And the control unit 110A sends the generated external sound output signal to the external sound output unit 210.

As a result, the test sound is outputted from the speaker SP of the external sound output unit 210. During this outputting of the test sound, the control unit 110A gathers the result of sound pickup by the sound pickup unit 610 over an interval whose length is determined in advance.

Next, in a step S23, on the basis of the results of sound pickup that have been gathered, the control unit 110A calculates the sound pressure level of the test sound. And the control unit also calculates the difference between the sound pressure level of the test sound and the target sound pressure level.

Next, in a step S24, the control unit 110A makes a decision as to whether or not the difference calculation this time in the immediately preceding step S23 is the first difference calculation related to the target sound pressure level for this measurement subject frequency. If the result of this decision in the step S24 is affirmative (Y in the step S24), then the flow of control proceeds to the step S25.

In this step S25, on the basis of the difference that has been calculated, the control unit 110A derives a gain value for which it is anticipated that the difference will become smaller. And the control unit 110A implements gain correction control according to this gain value that has been derived upon the test sound signal. Then the flow of control returns to the step S22.

Execution of the processing of the steps S22 through S24 is thus repeatedly performed two times or more, and, when the result of the decision in the step S24 becomes negative (N in the step S24), then the flow of control proceeds to a step S26. In this step S26, by making a decision as to whether or not the difference that has been newly calculated is less than the difference that was calculated the time before, the control unit 110A makes a decision as to whether or not the sound pressure level of the test sound has been brought closer to the target sound pressure level than by the difference calculation the time before.

If the result of the decision in the step S26 is affirmative (Y in the step S26), then the flow of control is transferred to the step S25. In the step S25, as described above, on the basis of the difference that has been calculated, a gain value is derived for which it is anticipated that the difference will become smaller. And the control unit 110A implements gain correction control upon the test sound signal according to this gain value that has been derived. Then the flow of control returns to the step S22.

Subsequently, the processing of the steps S22 through S26 is repeated until the result of the decision in the step S26 becomes negative. When the result of the decision in the step S26 becomes negative (N in the step S26), then the flow of control proceeds to the step S27.

In the step S27, the control unit 110A determines the gain value for which the difference that was calculated the previous time was obtained as being the optimum adjustment value corresponding to the measurement subject frequency. And, repeatedly, the control unit 110A registers the adjustment value that has been determined in the individual table corresponding to the measurement conditions in correspondence with the adjustment subject frequency which is the measurement subject frequency at the present time point. Subsequently, the flow of control is transferred to the step S15 of FIG. 5 described above.

As has been described above, adjustment values that satisfy the target sound pressure specifications stipulated in the measurement conditions for all of the adjustment subject frequencies are registered in the individual tables for those measurement conditions in the sound pressure adjustment table TBL in the storage unit 120.

### <<Operation During the Normal Operational Mode>>

Firstly, the operation when the normal operational mode has been specified by actuation by the user upon the input unit 150 will be explained. Note that, during the normal operational mode, the sound pickup unit 610 is not connected to the control unit 110A. Moreover it will be supposed that, during the normal operational mode and when the vehicle CR is traveling, an externally outputted sound is being outputted from the external sound output unit 210 in order to attract attention to the fact that the vehicle CR is approaching.

During the normal operational mode and when the vehicle CR is traveling, the control unit 110A refers to the individual table that has been set, according to the setting for the individual table to be referred to that has been most recently specified by input actuation by the user upon the input unit 150. And the control unit 110A performs control upon the external output signal in order to make the adjustment value registered in the individual table that has been referred to and corresponding to the adjustment subject frequency be the gain value for its component which has that adjustment subject frequency. As a result, externally outputted sound is outputted from the external sound output unit 210 with its output sound volume being minimized, while still satisfying the condition specified by the user for the required sound pressure level.

As has been explained above, according to this first example, during the sound pressure measurement operational mode, when measurement conditions including a pair of distance from the vehicle CR and required sound pressure level are specified, the control unit 110A outputs the test sound from the external sound output unit 210 as externally outputted sound by generating the test sound signal as the external sound output signal. By controlling the signal level of the test sound signal on the basis of the result of sound pick up of the test sound outputted to the exterior of the vehicle by the sound pickup unit 610, the control unit 110A obtains an adjustment value for the signal level of the test sound signal that is capable of minimizing the output sound volume, while the externally outputted sound propagating through the space external to the vehicle still satisfies the condition relating to the required sound pressure level. And the control unit 110A registers the adjustment value that has been obtained in the sound pressure adjustment table TBL in the storage unit 120.

Thus, according to this first example, it is possible to cause the externally outputted sound to be outputted with its sound volume being minimized, while still satisfying the condition upon the desired required sound pressure level.

Moreover, in this first example, if there are a plurality of adjustment subject frequencies, then an adjustment value for the signal level of the test sound signal is obtained for each of that plurality of adjustment subject frequencies. Due to this, it is possible to optimize the sound pressure level of the externally outputted sound very finely.

### The Second Example

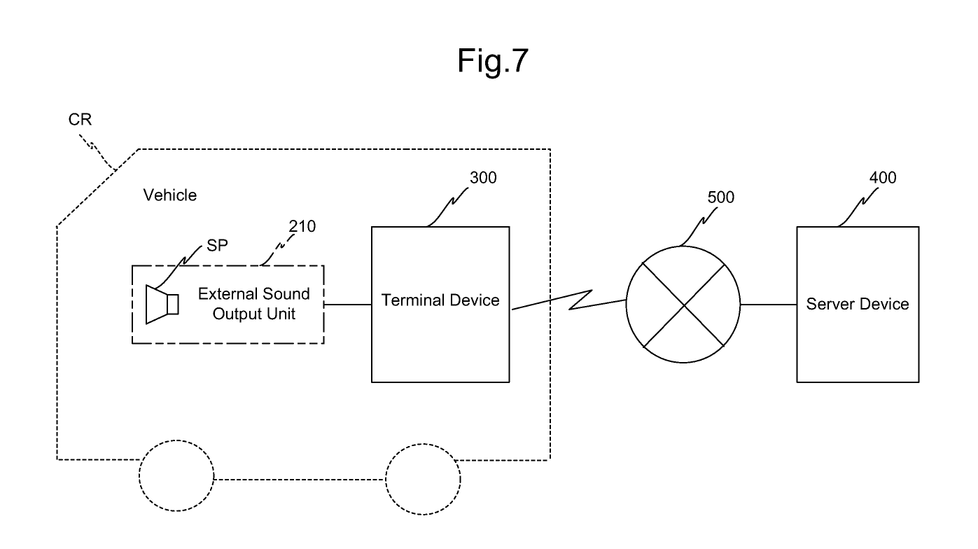

Next, a second example of the present invention will be explained with reference to FIGS. 7 through 9. This second example is a concrete example of the second embodiment described above (refer to FIG. 2).

### <Configuration>

The relationship between the positional relationship between a terminal device 300 and a server device 400 according to the second example is shown in FIG. 7. Note that the terminal device 300 is a concrete example of the terminal device 810 according to the second embodiment, while the server device 400 is a concrete example of the output sound management device 820 according to the second embodiment.

As shown in FIG. 7, the terminal device 300 is disposed within the vehicle 300. And an external sound output unit 210 is installed in this vehicle CR, in a similar manner to the case with the first example described above.

The server device 400 is disposed outside the vehicle CR. And the terminal device 300 and the server device 400 are capable of mutual communication via a network 500.

Note that the server device 400 is also capable of communication with other terminal devices that have configurations similar to that of the terminal device 300, but only the terminal device 300 is shown in FIG. 7, as a representative.

### <<Configuration of the Terminal Device 300>>

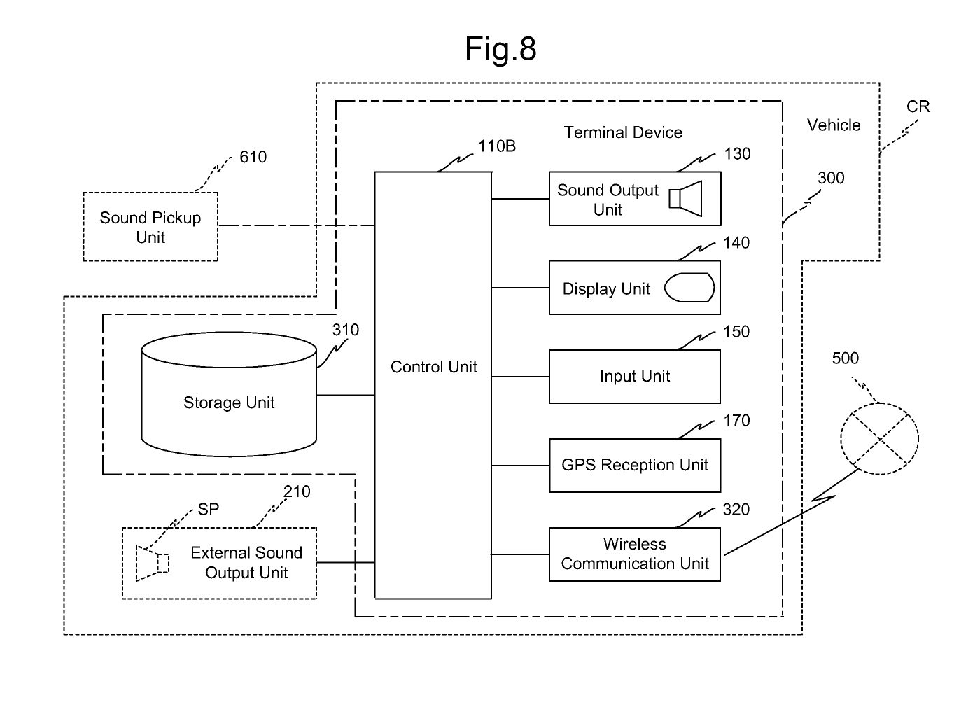

The schematic configuration of the terminal device 300 is shown in FIG. 8. As shown in this FIG. 8, as compared with the navigation device 100 of the first example described above, the terminal device 300 differs by the feature of being provided with a control unit 110B instead of the control unit 110A, and by the feature of being provided with a storage unit 310, which serves as the storage part 815, instead of the storage part 815. Moreover, as compared with the navigation device 100 of the first example, the terminal device 300 also differs by the feature of not being provided with any sensor unit 160, and by the feature of being further provided with a wireless communication unit 320 that serves as the transmission part 811 and as the reception part 812. In the following, the explanation will principally focus upon these points of difference.

The control unit 110B includes a central processing device (CPU) and its peripheral circuitry, and controls the entire terminal device 300 as a whole. By this control unit 110B executing programs of various types, it is arranged for functions of various types to be implemented by the terminal device 300. The functions of the acquisition part 730, of the control part 740B, and of the sound signal generation part 760 of the second embodiment described above are also included among the functions of these types. Note that the control unit 110B acquires GPS data from a GPS reception unit 170, and is adapted to specify the current position and the current time on the basis of this GPS data that has been acquired.

During the sound pressure measurement operational mode, the control unit 110B receives the results of sound pickup sent from the sound pickup unit 610. And the control unit 110B sends this sound pickup result to the wireless communication unit 320 as terminal transmission data. Moreover, during the sound pressure measurement operational mode, when input actuation for setting measurement conditions is performed upon the input unit 150, the control unit 110B sends these measurement conditions that have been set to the wireless communication unit 320 as terminal transmission data.

Furthermore, during the sound pressure measurement operational mode, the control unit 110B receives control information for the sound pressure level of the externally sound outputted by the external sound output unit 210, transmitted from the server device 400 via the network 500 and the wireless communication unit 320. And the control unit 110B controls the signal level of the test sound signal according to this control information. Moreover, in a similar manner to the case with the control unit 110A described above, the control unit 110B performs control of the signal level of the external output signal both during the sound pressure measurement operational mode and also during the normal operational mode.

Note that the details of the processing executed by the control unit 110B will be described hereinafter.

In a similar manner to the case with the storage unit 120 described above, the storage unit 310 includes a non-volatile storage device. It is arranged for the control unit 110B to be capable of accessing this storage unit 310. Moreover, note that the storage unit 310 does not store the speaker characteristic information SPD described above, so that in this aspect it differs from the storage unit 120.

The wireless communication unit 320 receives terminal transmission data sent from the control unit 110. And the wireless communication unit 320 transmits this terminal transmission data to the server device 400 via the network 500.

Furthermore, the wireless communication unit 320 receives control information and so on sent from the server device 400 via the network 500, wherein the control information specifies the sound pressure level of the test sound. And the wireless communication unit 320 sends the control information and so on to the control unit 110B.

### <<Configuration of the Server Device 400>>

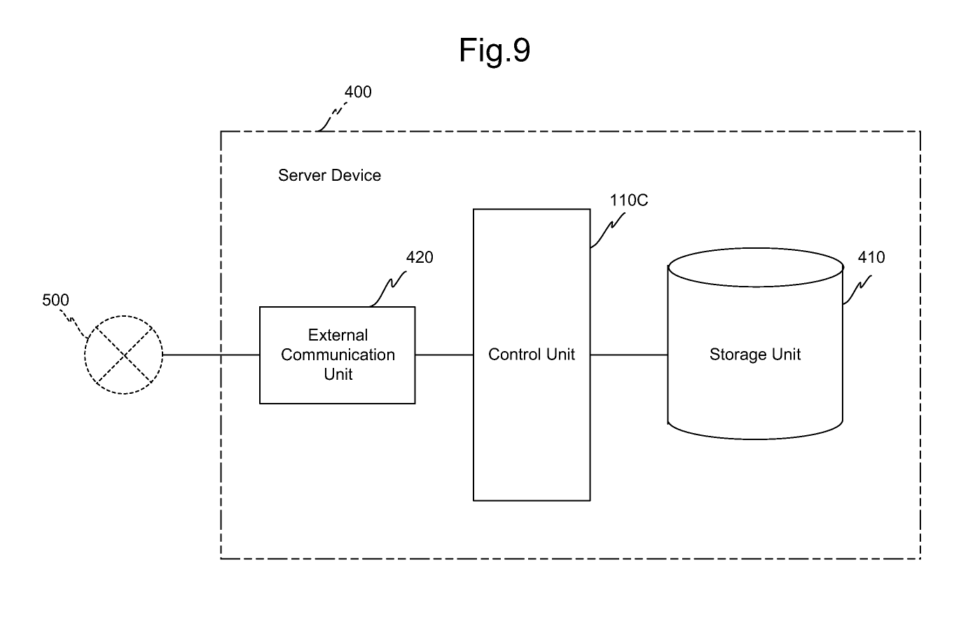

The schematic configuration of the server device 400 is shown in FIG. 9. As shown in this FIG. 9, the server device 400 comprises a control unit 110C, a storage unit 410 that fulfills the function of the storage part 825 of the second embodiment, and an external communication unit 420 that fulfills the functions of the reception part 821 and of the transmission part 823.

The control unit 110C includes a central processing device (CPU) and its peripheral circuitry, and controls the entire server device 400 as a whole. By this control unit 110C executing programs of various types, it is arranged for functions of various types to be implemented by the server device 400. The function of the generation part 822 of the second embodiment described above is also included among the functions of these types.

Note that the details of the processing executed by the control unit 110C will be explained hereinafter.

Information and data of various types utilized by the server device 400 are stored in the storage unit 410 mentioned above. The control unit 110C is adapted to be capable of accessing this storage unit 410. Note that the speaker characteristic information SPD described above is included in the information and data stored by the storage unit 410.

The external communication unit 420 mentioned above receives terminal transmission data transmitted from the terminal device 300 via the network 500. And the external communication unit 420 transmits this terminal transmission data to the control unit 110C.

Furthermore, the external communication unit 420 receives server transmitted data such as control information and so on sent from the control unit 110C. And the external communication unit 420 sends this server transmitted data to the terminal device 300 via the network 500.

With the configuration of the terminal device 300 and the configuration of the server device 400 as described above, the terminal transmission data that is outputted from the control unit 110B is sent to the control unit 110C via the wireless communication unit 320, the network 500, and the external communication unit 420. Moreover, the server transmitted data that is outputted from the control unit 110C is sent to the control unit 110B via the external communication unit 420, the network 500, and the wireless communication unit 320.

### <Operation>

Next, the control procedure for directionality of the externally outputted sound performed in cooperation by the terminal device 300 and the server device 400 having configurations as described above will be explained.

### <<Operation During the Sound Pressure Measurement Operational Mode>>

Firstly, the operation when the sound pressure measurement operational mode has been specified by actuation by the user upon the input unit 150 of the terminal device 300 will be explained. Note that it will be supposed that, before setting of the measurement conditions by actuation upon the input unit 150 by the user, along with the microphone of the sound pickup unit 610 being disposed in a position external to the vehicle CR that corresponds to the target directionality, also the sound pickup unit 610 is connected to the control unit 110B of the terminal device 300.

When the setting of the measurement conditions has been performed, the control unit 110B sends the measurement conditions that have been set to the control unit 110C of the server device 400. And, upon receipt of these measurement conditions, in a similar manner to the case with the control unit 110A of the first embodiment, the control unit 110C determines a target sound pressure level for the sound pickup unit 610 for each of the adjustment subject frequencies included in those measurement conditions, while referring to the speaker characteristic information SPD in the storage unit 410. And the control unit 110C sends control information to the control unit 110B in which the first measurement subject frequency and a prearranged gain value are specified.

Upon receipt of this control information, the control unit 110B generates a test sound signal corresponding to the measurement subject frequency and to the gain value specified in the control information, in a similar manner to the case for the control unit 110A. And the control unit 110B sends the generated test sound signal to the external sound output unit 210 as an external sound output signal. As a result, the test sound is outputted from the speaker SP of the external sound output unit 210.

During the output of this test sound, the control unit 110B receives the sound pickup result send from the sound pickup unit 610. And the control unit 110B sends this sound pickup result to the control unit 110C.

Upon receipt of the sound pickup result, the control unit 110C calculates, on the basis of this sound pickup result, the difference between the sound pressure level at the sound pickup position of the test sound and the target sound pressure level, in a similar manner to the case with the control unit 110A described above. Subsequently, on the basis of the difference that has been calculated and the gain value at the present time point, the control unit 110C derives a gain value for which it is anticipated that the difference will become smaller. Then the control unit 110C sends a gain correction specification to the gain value that has been derived to the control unit 110B as control information.

Upon receipt of this control information including the details of the gain correction specification, the control unit 110B, after having started generation of a test sound according to the gain correction specification, also sends a report, which means that gain correction control has been started, to the control unit 110C.

After that, when transmitting the result of sound pickup by the sound pickup unit 610 to the control unit 110C, the control unit 110B repeats the gain correction control according to the control information sent from the control unit 110C and the reporting of the start of gain correction control to the control unit 110C. Moreover, after the control unit 110C has received the report of the start of gain correction control sent from the control unit 110B, it repeats the difference calculation on the basis of the sound pickup result sent from the control unit 110B, until the difference that has been newly calculated becomes greater than or equal to the difference calculated the previous time.

And when the difference that has been newly calculated becomes greater than or equal to the difference that was calculated the time before, then the control unit 110C determines the gain value for which that difference that was calculated the time before was obtained as being the adjustment value that corresponds to the measurement subject frequency at the present time point. And the control unit 110C sends to the control unit 110B an individual measurement end notification including the pair consisting of the measurement subject frequency at the present time point and the adjustment value that has been determined. Upon receipt of this individual measurement end notification, in a similar manner to the case for the control unit 110A described above, the control unit 110B registers this gain value that has been determined in the sound pressure adjustment table TBL in the storage unit 310, as the adjustment value corresponding to the measurement subject frequency at the present time point.

Subsequently, the control unit 110B and the control unit 110C repeat processing similar to that described above, until an adjustment value has been determined corresponding to each of the adjustment subject frequencies that were set in the measurement conditions. And, after an individual measurement end notification has been sent for all of the adjustment subject frequencies set in the measurement conditions, then the control unit 110C sends a measurement end notification to the control unit 110B.

As has been described above, an adjustment value for the signal level of the external sound output signal corresponding to the measurement conditions set by the user is determined, and is registered in the sound pressure adjustment table TBL in the storage unit 310.

### <<Operation During the Normal Operational Mode>>

Next, the operation when the normal operational mode has been specified by actuation by the user upon the input unit 150 will be explained. Note that, during the normal operational mode, the sound pickup unit 610 is not connected to the control unit 110B of the terminal device 300. Moreover it will be supposed that, during the normal operational mode and when the vehicle CR is traveling, external sound is being outputted from the external sound output unit 210 in order to attract attention to the fact that the vehicle CR is approaching.

When the vehicle CR is traveling during the normal operational mode, in a similar manner to the case with the control unit 110A described above, the control unit 110B refers to the individual table that has been set according to the most recent setting specified by the user for the individual table that is to be referred to. And the control unit 110B implements control upon the external output signal in order to make the adjustment value corresponding to the adjustment subject frequency registered in the individual table that is referred to be the gain value for its component of that adjustment subject frequency. As a result, externally outputted sound whose output sound volume has been minimized is outputted from the external sound output unit 210, while still satisfying the condition specified by the user upon the required sound level.

As has been explained above, according to this second example, during the sound pressure measurement operational mode, on the basis of the result of sound pickup by the sound pickup unit 610 of the test sound that has been outputted to the exterior of the vehicle CR, the control unit 110B of the terminal device 300 controls the signal level of the test sound signal in cooperation with the control unit 110C of the server device 400. By performing this sort of control, an adjustment value for the signal level of the test sound signal is obtained that can minimize the output sound volume, while the externally outputted sound that is propagating through the space external to the vehicle still satisfies the condition upon the required sound pressure level. And the adjustment value that has been obtained is registered in the sound pressure adjustment table in the storage unit 310.

Thus, according to this second example, in a similar manner to the case with the first example described above, it is possible to output external sound whose sound volume is minimized while still satisfying the condition for the desired required sound pressure level.

Moreover, according to this second example, in a similar manner to the case with the first example, if there is a plurality of adjustment subject frequencies, then an adjustment value for the signal level of the test sound signal is obtained for each of this plurality of adjustment subject frequencies. By doing this, it is possible to perform very fine optimization of the sound pressure level of the externally outputted sound.

### Modification of the Examples

The first and second examples described above may be altered in various ways.

For example, in the first and second examples described above, when the difference that has been newly calculated becomes greater than or equal to the difference calculated the time before, then it is arranged to register, as the adjustment value in the sound pressure adjustment table TBL, the gain value for which the difference that was calculated that time before was obtained. By contrast to this it would also be acceptable to arrange, when the difference that has been calculated becomes less than or equal to some permitted value that is determined in advance, to register the gain value at that time point as the adjustment value in the sound pressure adjustment table TBL.

Moreover, in the first and second examples, during determination of the adjustment values, it was arranged to output a test sound for each of the adjustment subject frequencies, and to determine an adjustment value corresponding to each of the adjustment subject frequencies. By contrast to this it would also be acceptable, during determination of the adjustment values, to output a sound during the normal operational mode based upon sound data corresponding to the externally outputted sound as a test sound, and to determine an adjustment value corresponding to each adjustment subject frequency while performing frequency analysis of the result of sound pickup.

Moreover, in the first and second examples, it was arranged to employ a single sound pickup unit 610, and to perform measurement of the sound pressure level without changing the position of that sound pickup unit 610. By contrast to this, if there are a plurality of distances from the vehicle at which it is necessary to perform measurement of the sound pressure level as specified in the measurement conditions, then it will be acceptable to arrange, each time the sound pressure level has been measured at one distance, to change the position of the microphone of the sound pickup unit 610 to another of the positions specified by the measurement conditions.

Moreover, in the first and second examples, it was supposed that a single sound pickup unit 610 was used. By contrast to this, it would also be acceptable to employ an appropriate number of sound pickup units of different types and/or at different distances from the vehicle for performing measurement of sound pressure levels specified by the measurement conditions, and to arrange the microphones of these sound pickup units at each of these distances so as to perform measurement of the sound pressure levels. In this case, it would be possible to omit the processing for determination of the target sound pressure level.

Moreover, in the first example, it was arranged for the storage unit of the navigation device to store the sound source data. By contrast to this, if a storage unit that is included in some other device and that can be shared serves as a storage unit for storing the sound source data, then it would also be acceptable to arrange to employ that sharable storage unit. In this case, it would be possible to omit the sound source data from the information that is stored in the storage unit of the navigation device.

Moreover, in the first example, it was arranged for the control unit of the navigation device to generate the external sound output signal. By contrast to this, for example, it would also be acceptable to arrange for the external sound output unit to generate the external sound output signal.

Moreover, in the second example, it was arranged for the storage unit of the terminal device to store the sound source data. By contrast to this, if a storage unit that is included in some other device and that can be shared serves as a storage unit for storing the sound source data, then it would also be acceptable to arrange to employ that sharable storage unit. In this case, it would be possible to omit the sound source data from the information that is stored in the storage unit of the terminal device.

Moreover, in the second example, the terminal device 300 was built to include the sound output unit 130, the display unit 140, and the GPS reception unit 160. By contrast to this, it would also be acceptable to arrange for the terminal device only to perform the processing corresponding to externally outputted sound, and to omit the sound output unit 130, the display unit 140, and the GPS reception unit 160 as structural elements of the terminal device.

Moreover, in the second example described above, it was arranged for the server device to keep the speaker characteristic information. By contrast to this, it would also be acceptable to arrange for the speaker characteristic information to be transmitted from the terminal device to the server device, each time measurement conditions are generated.

1. An acoustic device that supplies an external sound output signal to an external sound output part that outputs sound to the exterior of a vehicle, comprising:
a first acquisition part configured to acquire the sound pressure level of sound outputted by said external sound output part and picked up by a sound pickup part that is disposed at a predetermined position exterior to the vehicle; and
a control part configured to control the signal level of said external sound output signal on the basis of the sound pressure level acquired by said first acquisition part and a target sound pressure level for said predetermined position.

2. The acoustic device according to claim 1, wherein
said control part controls the signal level of said external sound output signal so that the sound pressure level acquired by said first acquisition part approaches said target sound pressure level.

3. The acoustic device according to claim 1, wherein
said target sound pressure level is determined of each of certain frequencies that are determined in advance;
said first acquisition part acquires a sound pressure level of the sound outputted by said external sound output part for each of said frequencies that are determined in advance; and
said control part controls the signal level of said external sound output signal for each of said frequencies that are determined in advance.

4. The acoustic device according to claim 1, further comprising a second acquisition part configured to acquire a specification for said target sound pressure level, and to send said target sound pressure level that has been specified to said control part.

5. The acoustic device that supplies an external sound output signal to an external sound output part that outputs sound to the exterior of a vehicle comprising:
an acquisition part configured to acquire the sound pressure level of sound outputted by said external sound output part and picked up by a sound pickup part that is disposed at a predetermined position exterior to the vehicle; and
a control part configured to control the signal level of said external sound output signal so that said sound pressure level approaches a sound pressure level that is set for said predetermined position.

6. An output sound management device comprising:
a reception part configured to receive the sound pressure level of sound outputted by an external sound output part that is installed to the vehicle and picked up by a sound pickup part that is disposed at a predetermined position exterior to the vehicle;
a generation part configured to generate signal level control information for said external sound output signal on the basis of the result of reception by said reception part and a target sound pressure level at said predetermined position; and
a transmission part configured to transmit the result of generation by said generation part.

7. A terminal device disposed in a vehicle comprising:
a sound pressure level acquisition part configured to acquire the sound pressure level of sound outputted by an external sound output part and picked up by a sound pickup part, the external sound output part being installed to said vehicle, the sound pickup part being disposed at a predetermined position exterior to the vehicle;
a transmission part configured to transmit the result of acquisition by said sound pressure level acquisition part;
a reception part configured to receive control information for the signal level of an external sound output signal, the control information being generated on the basis of the result of acquisition by said sound pressure level acquisition part and a target sound pressure level for said predetermined position; and
a control part configured to control the signal level of said external sound output signal on the basis of the result of reception by said reception part.

8. An output sound control method that controls an external sound output signal to an external sound output part that outputs sound to the exterior of a vehicle, comprising the steps of:
an acquisition step of acquiring the sound pressure level of sound outputted by said external sound output part and picked up by a sound pickup part that is disposed at a predetermined position exterior to the vehicle; and
a control step of controlling the signal level of said external sound output signal on the basis of the result of acquisition by said acquisition process and a target sound pressure level at said predetermined position.

9. (canceled)

10. A recording medium, wherein
a non-transient computer readable medium having recorded therein an output sound control program that, when executed, causes a calculation part to execute the output sound control method according claim 8.
